(19) United States
(12) Patent Application Publication
(10) Pub. No.: US 2012/0158809 A1
(43) Pub. Date: Jun. 21, 2012

(54) Compensation Filtering Device and Method Thereof

(76) Inventors: Toshifumi Yamamoto, Tokyo (JP); Yasuhiro Kanishima, Tokyo (JP)

(21) Appl. No.: 13/178,184

(22) Filed: Jul. 7, 2011

(30) Foreign Application Priority Data
Dec. 17, 2010 (JP) 2010-282247

(51) Int. Cl. G06F 17/10

(52) U.S. Cl. 708/300

(57) ABSTRACT

According to one embodiment, a compensation filtering device includes an impulse response calculator, a coefficient calculator, and an adder. The impulse response calculator calculates an impulse response of a reproduction system comprising a sound field. The coefficient calculator calculates a compensation coefficient to compensate for a tap coefficient such that a direct current gain of an extracted finite impulse response (FIR) filter with a predetermine number of taps extracted from an FIR filter having reverse characteristics of the impulse response takes a predetermined value. The tap coefficient indicates a weight of each of the taps. The adder adds the compensation coefficient to the tap coefficient of each of the taps of the extracted FIR filter to generate a compensation filter to compensate for acoustic characteristics of the reproduction system.

### CROSS-REFERENCE TO RELATED APPLICATIONS

This application is based upon and claims the benefit of priority from Japanese Patent Application No. 2010-282247, filed Dec. 17, 2010, the entire contents of which are incorporated herein by reference.

### FIELD

Embodiments described herein relate generally to a compensation filtering device and a method thereof.

### BACKGROUND

In various types of conventional AV equipment such as a television, when sound is output, various factors exist that degrade reproduced sound quality of an audio signal. Accordingly, there have been proposed various technologies to output sound with quality faithful to the original.

For example, there has been proposed a technology for compensating for response characteristics in a reproduction system configured to include a sound field using a finite impulse response (FIR) filter. In the FIR filter, the characteristics vary depending on the number of taps constituting the FIR filter and a coefficient indicating a weight for each tap (hereinafter, “tap coefficient”). As the number of taps increases, the frequency resolution of the FIR filter increases and the filter performance improves. However, the larger number of taps increase the arithmetic processing load.

In view of this, there has been proposed a conventional technology for obtaining a filter coefficient of the FIR filter with a limited number of taps. For example, the frequency characteristic is combined with the phase compensation characteristic to obtain a combined compensation characteristic. The combined compensation characteristic is used as the filter coefficient of a compensation filter.

The filter coefficient can be obtained not only by combining the frequency characteristic with the phase compensation characteristic as in the conventional technology, but may be obtained in a different manner. Further, with the conventional technology, it is difficult to control the direct current (DC) gain of the compensation filter.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an acoustic reproduction device according to an embodiment;

FIG. 2 is an exemplary graph of impulse response of a reproduction system measured after calculated by an impulse response calculator in the embodiment;

FIG. 3 is an exemplary graph of amplitude-frequency characteristics of the impulse response illustrated in FIG. 2 in the embodiment;

FIG. 4 is an exemplary graph of phase-frequency characteristics of the impulse response illustrated in FIG. 2 in the embodiment;

FIG. 5 is an exemplary graph of the tap coefficients of a finite impulse response (FIR) filter indicating reverse characteristics of the impulse response illustrated in FIG. 2 in the embodiment;

FIG. 6 is an exemplary graph of amplitude-frequency characteristics corresponding to the tap coefficients of the FIR filter illustrated in FIG. 5 in the embodiment;

FIG. 7 is an exemplary graph of phase-frequency characteristics corresponding to the tap coefficients of the FIR filter illustrated in FIG. 5 in the embodiment;

FIG. 8 is an exemplary graph of tap coefficients of taps extracted by a tap extractor illustrated in FIG. 5 in the embodiment;

FIG. 9 is an exemplary graph of amplitude-frequency characteristics corresponding to the tap coefficients illustrated in FIG. 8 in the embodiment;

FIG. 10 is an exemplary graph of phase-frequency characteristics corresponding to the tap coefficients illustrated in FIG. 8 in the embodiment;

FIG. 11 is an exemplary diagram illustrating the correspondence between variables indicating samples at both ends and values assigned to the variables in the embodiment;

FIG. 12 is an exemplary graph of the head of a coefficient string of 256 coefficients in the embodiment;

FIG. 13 is an exemplary graph of the end of the coefficient string of 256 coefficients in the embodiment;

FIG. 14 is an exemplary graph of a coefficient string of compensation coefficients obtained by multiplying each coefficient by a calculated variable in the embodiment;

FIG. 15 is an exemplary graph of the difference in tap coefficients before and after addition of a compensation coefficient at the head of tap coefficients in the embodiment;

FIG. 16 is an exemplary graph of amplitude-frequency characteristics corresponding to tap coefficients of a compensation filter after addition of the compensation coefficient in the embodiment;

FIG. 17 is an exemplary graph of amplitude-frequency characteristics of the compensation filter before and after addition of the compensation coefficient in the embodiment; and

FIG. 18 is an exemplary flowchart of the operation of the acoustic reproduction device to generate the compensation filter in the embodiment.

### DETAILED DESCRIPTION

In general, according to one embodiment, a compensation filtering device comprises an impulse response calculator, a coefficient calculator, and an adder. The impulse response calculator is configured to calculate an impulse response of a reproduction system comprising a sound field. The coefficient calculator is configured to calculate a compensation coefficient to compensate for a tap coefficient such that a direct current gain of an extracted finite impulse response (FIR) filter with a predetermine number of taps extracted from an FIR filter having reverse characteristics of the impulse response takes a predetermined value. The tap coefficient indicates a weight of each of the taps. The adder is configured to add the compensation coefficient to the tap coefficient of each of the taps of the extracted FIR filter to generate a compensation filter to compensate for acoustic characteristics of the reproduction system.

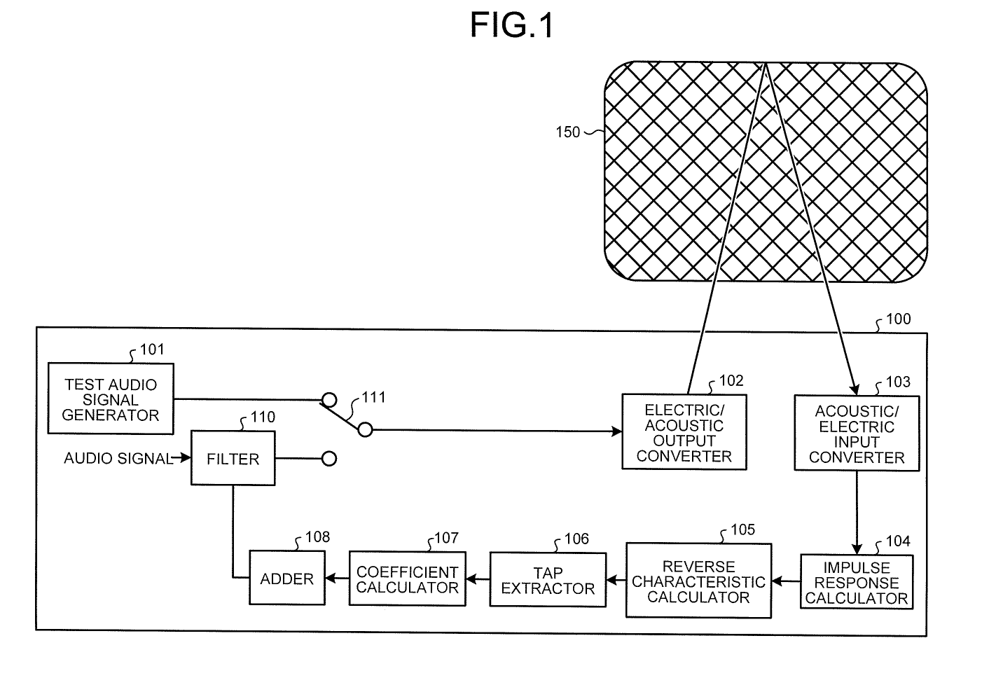

FIG. 1 is a block diagram of an acoustic reproduction device 100 according to an embodiment. As illustrated in FIG. 1, the acoustic reproduction device 100 employs a compensation filtering device that provides acoustic compensation using a filter. The acoustic reproduction device 100 comprises a test audio signal generator 101, an electric/acoustic output converter 102, an acoustic/electric input converter 103, an impulse response calculator 104, a reverse characteristic calculator 105, a tap extractor 106, a coefficient calculator 107, an adder 108, a filter 110, and a switch 111.

The switch 111 switches an audio signal output from the acoustic reproduction device 100 between an ordinary audio signal and a test audio signal received from the test audio signal generator 101. More specifically, if a compensation filter is generated, the switch 111 connects between the test audio signal generator 101 and the filter 110. Otherwise, the switch 111 connects between a terminal to output an ordinary audio signal and the filter 110.

The test audio signal generator 101 generates a test audio signal to measure acoustic characteristics (impulse response) of a reproduction system 150 comprising a reproduction sound field. In the embodiment, for example, a white noise signal, a time stretched pulse (TSP) signal, or the like is used as the test audio signal. The test audio signal need not necessarily be generated by the test audio signal generator 101 each time measurement is performed, but may be stored in a memory or the like and read therefrom.

The electric/acoustic output converter 102 converts the test audio signal or an audio signal to be listened to from an electrical signal to reproduction sound and outputs it. The electric/acoustic output converter 102 may comprise a digital/analog converter, a power amplifier, and the like.

The acoustic/electric input converter 103 picks up the test reproduction sound propagating in the reproduction system 150, and converts it from sound to an electrical signal. The acoustic/electric input converter 103 may comprise an analog/digital converter, a power amplifier, and the like.

The impulse response calculator 104 calculates an impulse response of the reproduction system 150 comprising a reproduction sound field from the electrical signal converted from the test reproduction sound.

The reproduction sound emitted from the electric/acoustic output converter 102 to the reproduction system 150 is influenced by natural vibration of the vibration system of the electric/acoustic output converter 102, the divided vibration of a vibration board, a standing wave generated in the housing, or a resonance in the housing. The reproduction sound is further subject to various influences such as duct resonance in the reproduction system 150, the reflection of a grill or a net existing in the reproduction system 150, and the like. Accordingly, the picked up test reproduction sound is disturbed in amplitude-frequency characteristics and phase-frequency characteristics compared to the test audio signal generated by the test audio signal generator 101.

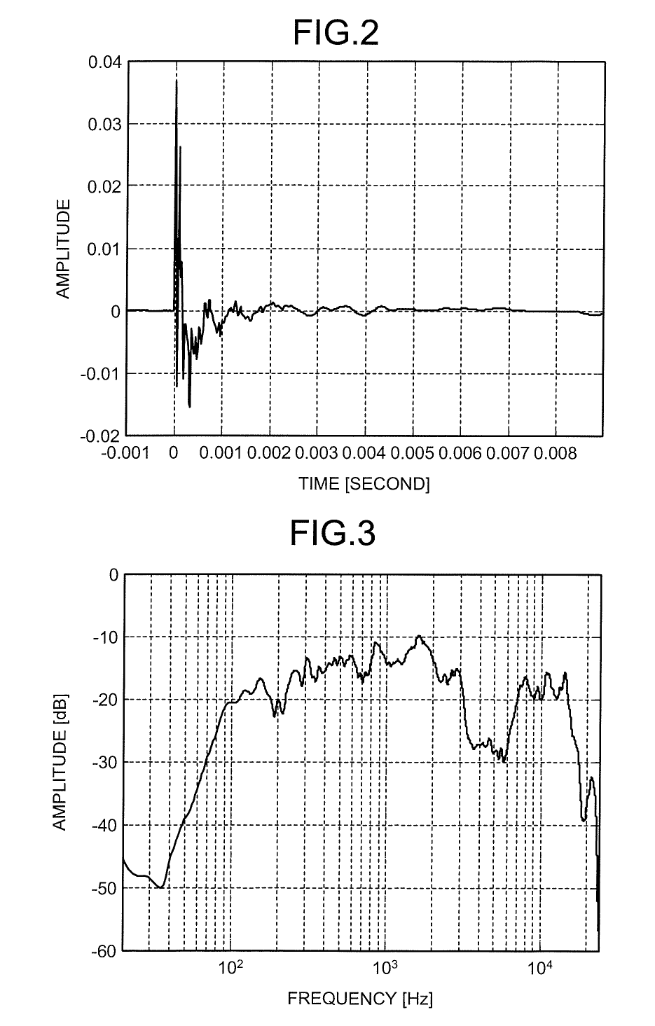

FIG. 2 illustrates a measurement example of the impulse response of the reproduction system 150 calculated by the impulse response calculator 104. In the example of FIG. 2, it is assumed that the sampling frequency is 48 kHz. The impulse response is checked about amplitude-frequency characteristics and phase-frequency characteristics.

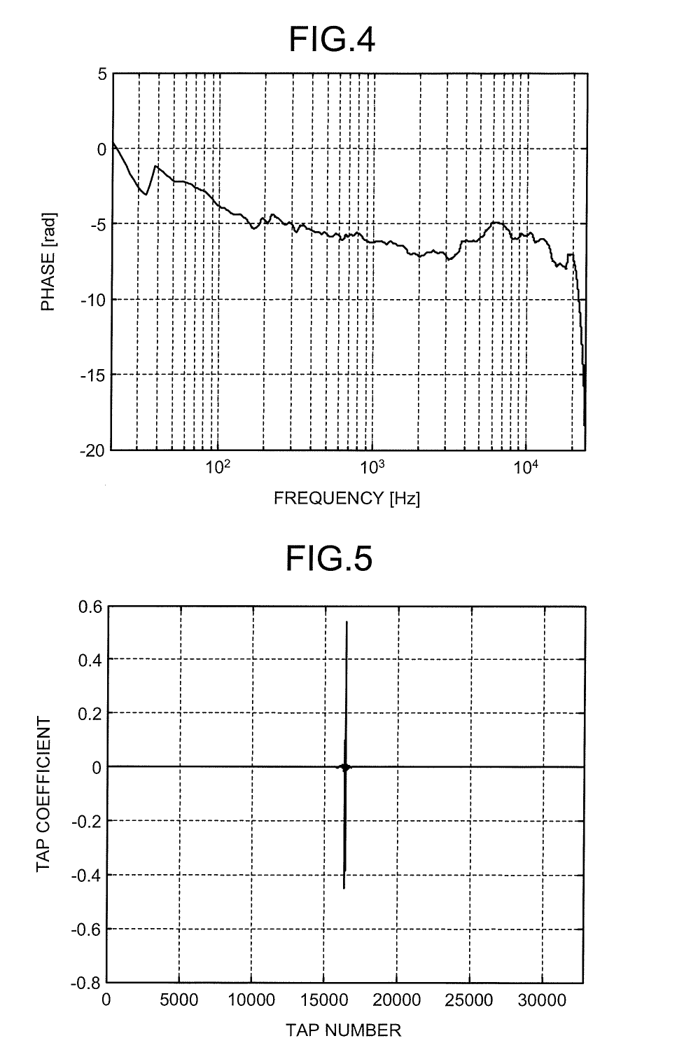

FIG. 3 illustrates the amplitude-frequency characteristics of the impulse response illustrated in FIG. 2. FIG. 4 illustrates the phase-frequency characteristics of the impulse response illustrated in FIG. 2. It can be seen from the example of FIGS. 3 and 4 that the amplitude-frequency characteristics and the phase-frequency characteristics are disturbed.

In view of this, the acoustic reproduction device 100 of the embodiment applies a finite impulse response (FIR) filter to compensation for the acoustic characteristics.

The reverse characteristic calculator 105 calculates the reverse characteristics of the impulse response calculated by the impulse response calculator 104. For example, the reverse characteristic calculator 105 takes the discrete Fourier transform of the impulse response and obtains a complex number in the frequency domain. The reverse characteristic calculator 105 then calculates the inverse of the complex number and further takes the discrete Fourier transform, thereby obtaining the reverse characteristics of the impulse response.

FIG. 5 illustrates the tap coefficients of the FIR filter indicating the reverse characteristics of the impulse response illustrated in FIG. 2. In the example of FIG. 5, the reverse characteristic calculator 105 sets −20.5 dB as a reference level, and performs the calculation by substituting the reference level −20.5 dB for original amplitude characteristics with respect to a low frequency range of 100 Hz or less and a high frequency range of 15 kHz or more. This calculation is aimed at avoiding a filter having a large compensation gain from being generated in a low frequency range of 100 Hz or less and a high frequency range of 15 kHz or more in spite of the fact that reproduction sound output from the electric/acoustic output converter 102 cannot respond in the frequency ranges. Incidentally, the term “tap coefficient” as used herein refers to a coefficient indicating a weight with respect to each tap.

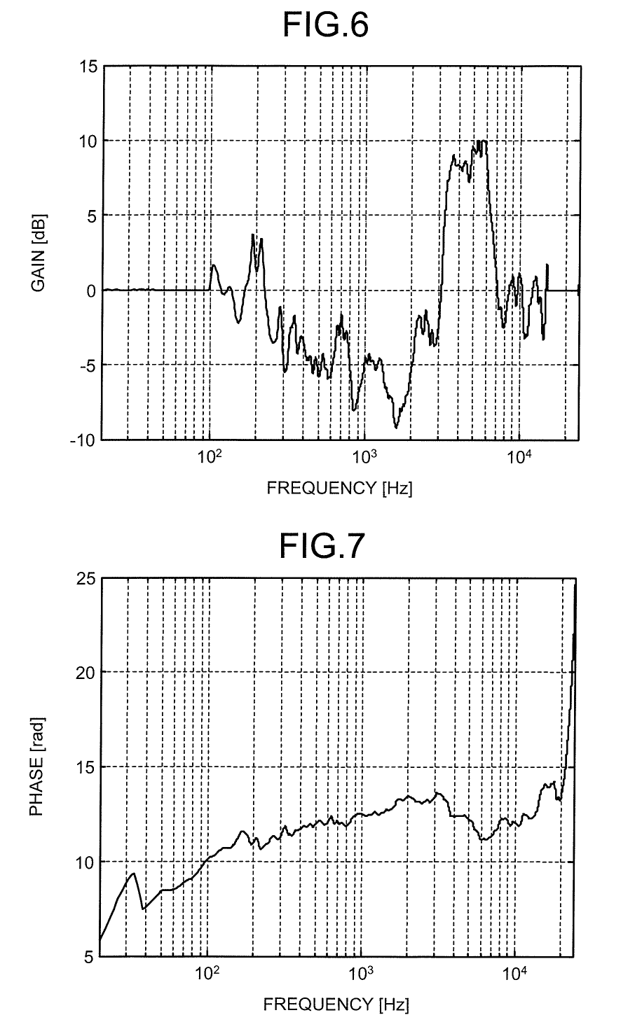

FIG. 6 illustrates amplitude-frequency characteristics corresponding to the tap coefficients of the FIR filter illustrated in FIG. 5. FIG. 7 illustrates phase-frequency characteristics corresponding to the tap coefficients of the FIR filter illustrated in FIG. 5. In the example of FIG. 6, the calculation is performed by substituting the reference level for a low frequency range of 100 Hz or less and a high frequency range of 15 kHz or more. As a result, it can be seen that the gain is 0 dB.

The amplitude-frequency characteristics illustrated in FIG. 6 represent a compensation gain based on the amplitude level “−20.5 dB” of FIG. 3 indicating amplitude-frequency characteristics of the impulse response of the reproduction system. The characteristic curve approximates characteristics obtained by reversing the amplitude-frequency characteristics of FIG. 3 about “−20.5 dB” as an axis. Thus, with the FIR filter having the tap coefficients as illustrated in FIG. 6, reproduction sound of flat amplitude-frequency characteristics is obtained in the range of 100 Hz to 15 kHz.

Meanwhile, the tap coefficients illustrated in FIG. 5 require substantial time to converge. Therefore, if an FIR filter is generated with the tap coefficients of FIG. 5, this results in a filter of 32768 taps. Such a filter necessitates enormous arithmetic processing and an increase in circuit size and power consumption.

To reduce the taps of the filter, there has been proposed a method in which data is extracted for a predetermined number of taps and installed as a filter. In the embodiment, the tap extractor 106 extracts an FIR filter corresponding to a predetermined number of taps from an FIR filter having reverse characteristics calculated by the reverse characteristic calculator 105.

The tap extractor 106 uses a window function such as Tukey (tapered cosine) window to extract a predetermined number of taps from an FIR filter having reverse characteristics. Tap coefficients of taps need not necessarily be extracted using a window function such as Tukey (tapered cosine) window, and other techniques may be used.

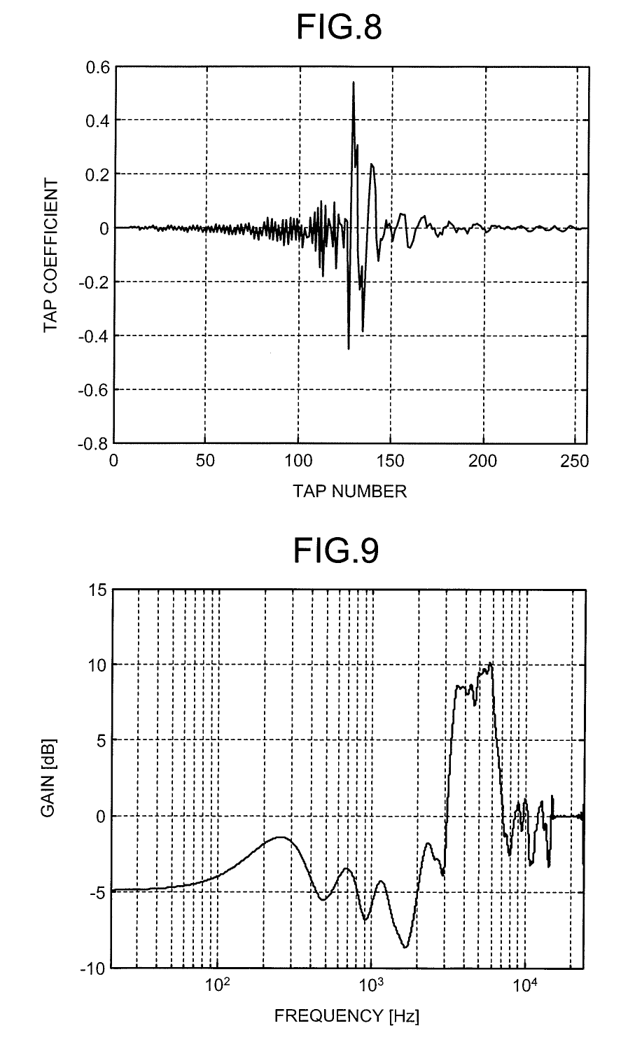

FIG. 8 illustrates tap coefficients extracted by the tap extractor 106. In the example of FIG. 8, tap coefficients of 256 taps are extracted from the tap coefficients of the FIR filter illustrated in FIG. 5.

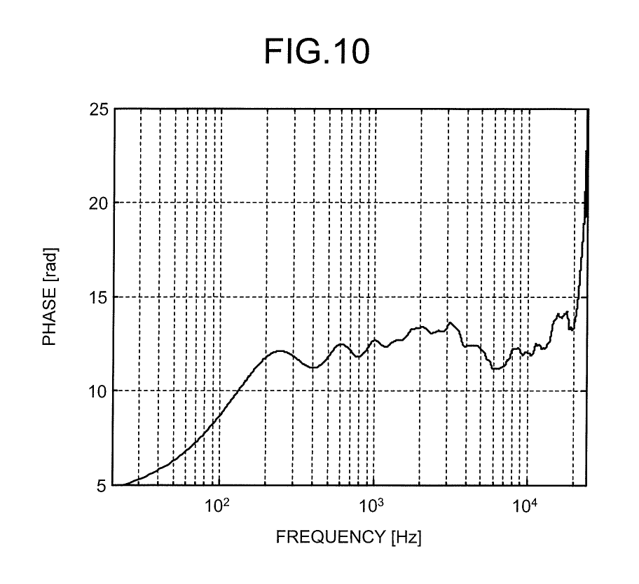

FIG. 9 illustrates amplitude-frequency characteristics corresponding to the tap coefficients illustrated in FIG. 8. FIG. 10 illustrates phase-frequency characteristics corresponding to the tap coefficients illustrated in FIG. 8. It can be seen that, in the amplitude-frequency characteristics of FIG. 9, the gain substantially reduces in the low frequency range compared to the amplitude-frequency characteristics before the extraction illustrated in FIG. 6.

This is based on that impulse response needs more time to converge with an increase in group delay due to the phase rotation of reproduction sound. That is, in the FIR filter, although the convergence time of impulse response is prolonged because of the characteristics to return group delay, extraction is performed with respect to the impulse response, i.e., the number of taps are limited. As a result, components of the low frequency range where the group delay is large are cut off.

For this reason, the embodiment focuses on such property that the absolute value of the sum of the tap coefficients of the FIR filter provides the direct current (DC) gain of the filter. Thus, the coefficient calculator 107 calculates the sum of the tap coefficients of the extracted compensation filter and further calculates a compensation coefficient that equals the difference between the absolute value of the sum and “1”. The adder 108 adds the calculated compensation coefficient to the tap coefficients of the extracted compensation filter.

The coefficient calculator 107 calculates compensation coefficients to compensate for tap coefficients such that the DC gain of an FIR filter of a predetermined number of taps (in the embodiment, for example, 256 taps) extracted from an FIR filter having reverse characteristics of the impulse response becomes a predetermined value (in the embodiment, “1”), i.e., the absolute value of the sum of the tap coefficients becomes “1”.

The coefficient calculator 107 of the embodiment calculates the compensation coefficients to compensate for the tap coefficients of the extracted FIR filter in a manner described below. In the embodiment, to avoid unnecessary frequency characteristics as characteristics of a coefficient string, the coefficient calculator 107 calculates the coefficient string of compensation coefficients corresponding to 256 taps based on the Tukey (tapered cosine) window function.

Both ends of the Tukey (tapered cosine) window function are in the form of raised cosine. Among 256 coefficients, the n-th (n=0 to N) sample value at the both ends is calculated by the following Equation 1:

$${y}_{n} = \frac{( 1 - cos ( \frac{2 π n}{N} ) )}{2} \qquad ( 1 )$$

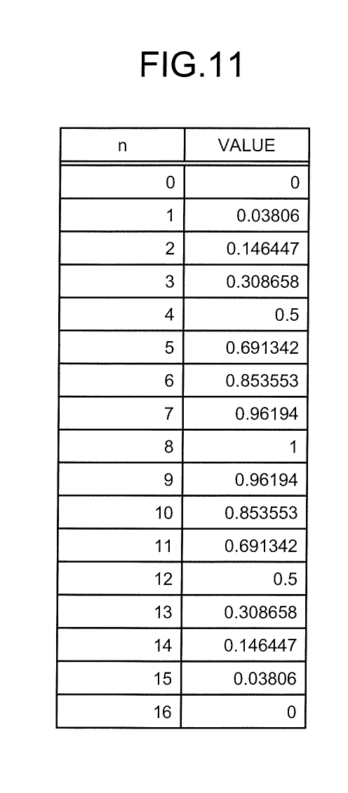

Incidentally, among extracted tap numbers, N can be any value appropriate for the samples at the both ends of the Tukey (tapered cosine) window function. In the embodiment, for example, N=16. FIG. 11 illustrates the correspondence between variables indicating the samples at the both ends and values assigned to the variables. The 16 values calculated in the example of FIG. 11 are applied to the following taps. That is, eight coefficients from n=0 to n=7 are set to the top eight taps of 256 taps, 1 is set to 9th to 248th taps, and coefficients from n=9 to n=16 are set to the last eight 249th to 256th taps. Thus, a coefficient string corresponding to the 256 taps is generated.

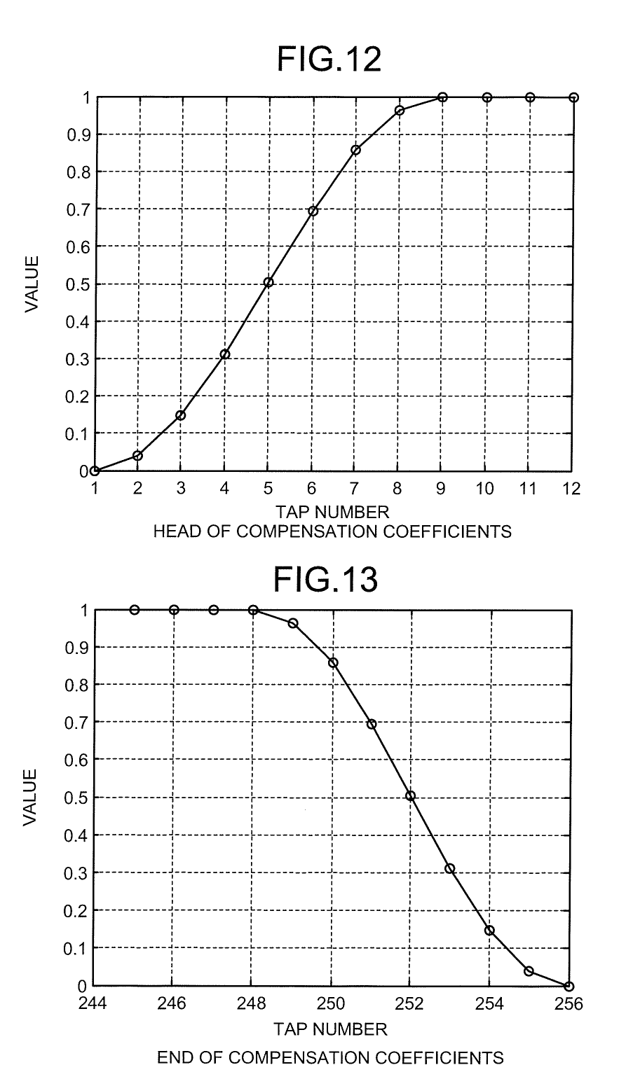

FIG. 12 illustrates the head of the coefficient string of 256 coefficients. FIG. 13 illustrates the end of the coefficient string of 256 coefficients. The sum of the values from n=0 to n=7 and from n=9 to n=16 is “7”. This is based on that, by using a raised cosine function, the sum of sample number 2 and sample number 8 is 1, the sum of sample number 3 and sample number 7 is 1, the sum of sample number 4 and sample number 6 is 1, and the value of sample number 5 is 0.5, resulting in 3.5 on one side. Since the value of 240 out of 256 coefficients except both ends is “1”, the total sum of coefficients contained in the coefficient string is 247.

The coefficient calculator 107 multiplies each coefficient of the coefficient string except both ends by a variable k, thereby calculating a compensation coefficient string, i.e., a string of compensation coefficients. The values of compensation coefficients at both ends of the compensation coefficient string are obtained by multiplying the variable k by values illustrated in FIG. 11. The values of 9th to 248th coefficients are k.

In the following, a description will be given of how to obtain the variable k. If it is assumed that the total sum of tap coefficients to be compensated for is S, then, it needs to be compensated for so that the absolute value of the total sum is “1” to set the DC gain to 1 (0 dB). Further, the coefficient calculator 107 needs to divide the value by 247 to obtain the variable k. The coefficient calculator 107 calculates the variable k by the following Equation 2 if S<0:

$$k = \frac{( - 1 - S )}{247} \qquad ( 2 )$$

The coefficient calculator 107 calculates the variable k by the following Equation 3 if S>0:

$$k = \frac{( 1 - S )}{247} \qquad ( 3 )$$

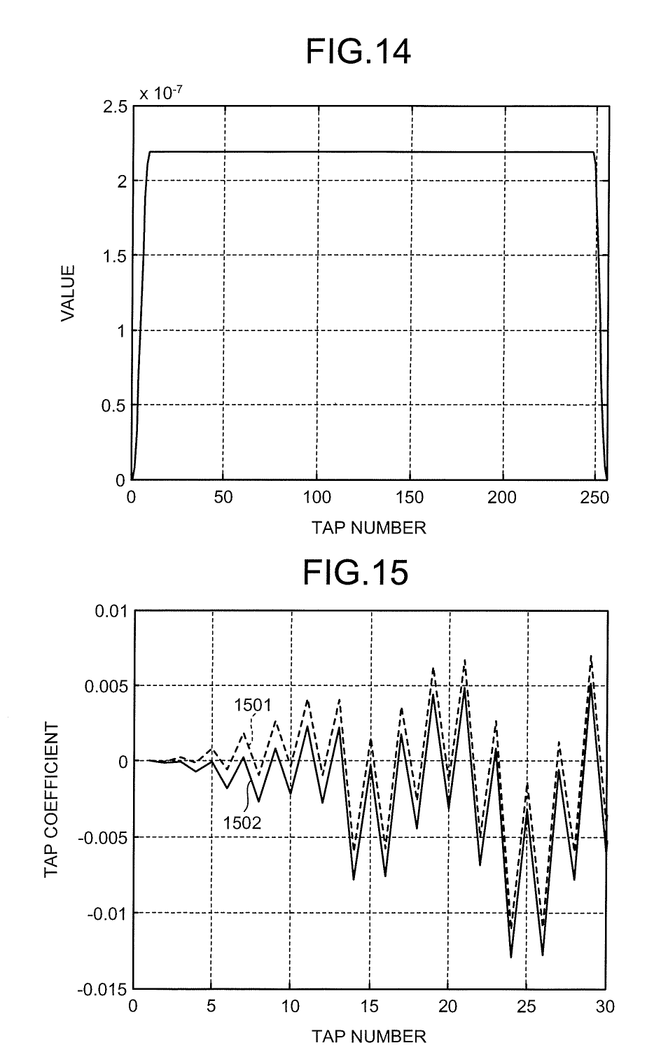

With this, the variable k can be obtained. FIG. 14 illustrates a coefficient string of compensation coefficients obtained by multiplying each coefficient by the calculated variable k. By adding each compensation coefficient of FIG. 14 to the tap coefficient of each tap, the DC gain of the FIR filter can be set to “1”.

The adder 108 adds a compensation coefficient contained in the compensation coefficient string to the tap coefficient of each tap of the extracted FIR filter, thereby generating a compensation filter to compensate for acoustic characteristics of the reproduction system. In the embodiment, the compensation coefficient is calculated by using the Tukey (tapered cosine) window function. As a result, a plurality of compensation coefficients contained in the middle of the coefficient string take the same value.

With this, a compensation filter used for filtering by the filter 110 is obtained. Incidentally, as illustrated in FIG. 14, the compensation coefficient applied to each tap takes very small value. Accordingly, the value of the compensation coefficient calculated by the coefficient calculator 107 is very small. Thus, even if the adder 108 adds the compensation coefficient to the tap coefficient, the tap coefficient changes a very little. The change of the tap coefficient will be described.

FIG. 15 illustrates the difference in tap coefficients before and after addition of compensation coefficients at the head of tap coefficients. In the example of FIG. 15, line 1501 indicates tap coefficients before addition of the compensation coefficients, while line 1502 indicates tap coefficients after addition of the compensation coefficients. As can be seen from FIG. 15, the tap coefficient of each tap of the extracted FIR filter is compensated for.

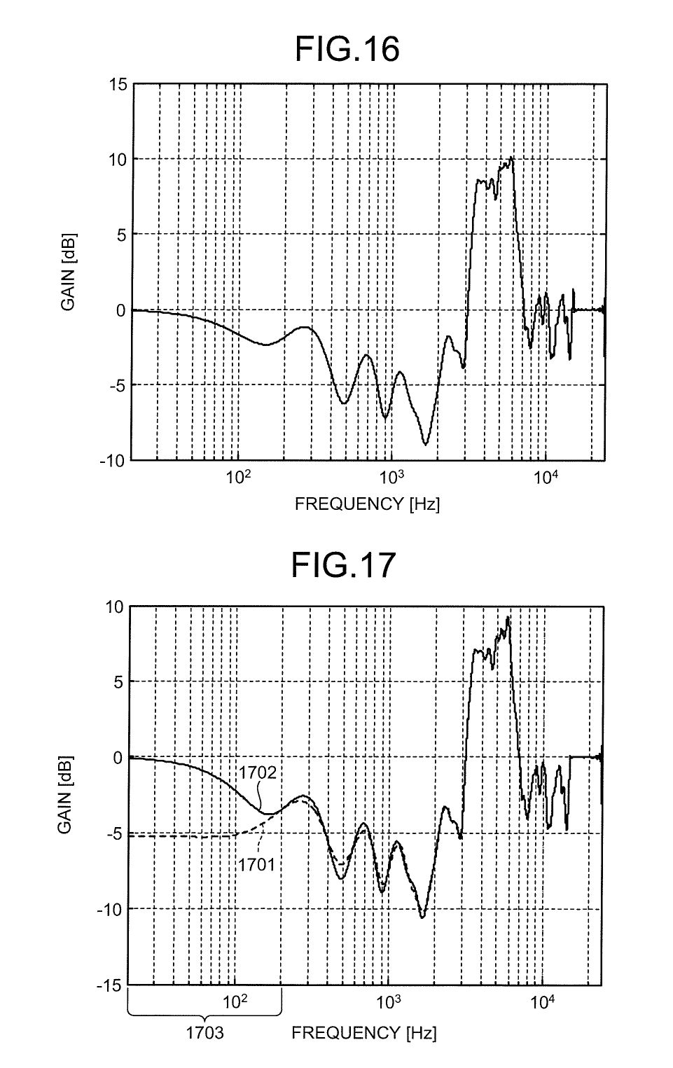

FIG. 16 illustrates amplitude-frequency characteristics corresponding to tap coefficients of the compensation filter after addition of compensation coefficients. It can be seen from FIG. 16 that since the tap coefficients are compensated for by the compensation coefficients, the DC gain becomes 1 (0 dB). Incidentally, phase characteristics corresponding to the tap coefficients of the compensation filter is basically similar to those of FIG. 10, and the description will not be provided.

FIG. 17 illustrates amplitude-frequency characteristics of the compensation filter before and after addition of compensation coefficients. In FIG. 17, line 1701 indicates amplitude-frequency characteristics before addition of the compensation coefficients, while line 1702 indicates amplitude-frequency characteristics after addition of the compensation coefficients. It can be seen from the example of FIG. 17 that the amplitude characteristics are appropriately compensated for in a low frequency range 1703.

The filter 110 performs filtering on an audio signal output from the electric/acoustic output converter 102 using the compensation filter generated by the adder 108.

With this configuration, the acoustic reproduction device 100 of the embodiment can perform appropriate filtering on an audio signal.

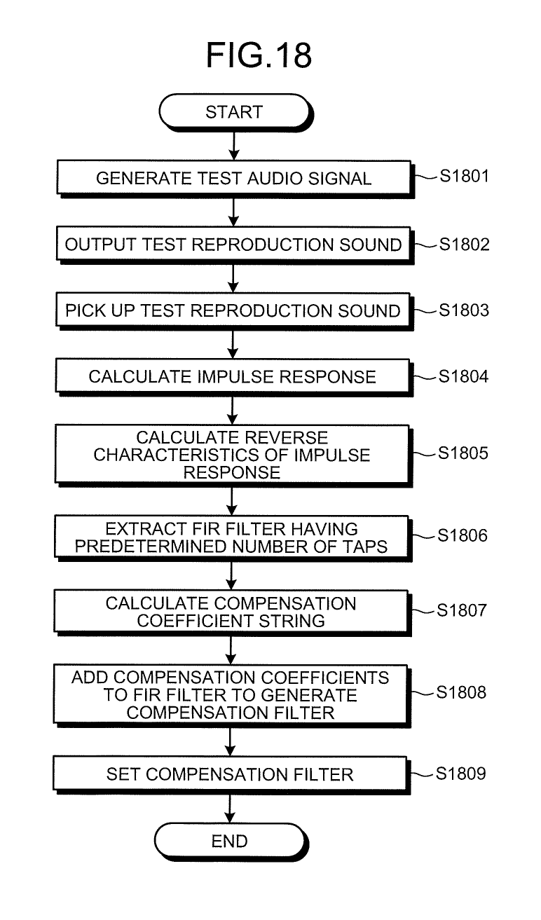

In the following, a description will be given of the operation of the acoustic reproduction device 100 to generate a compensation filter. FIG. 18 is a flowchart of the operation of the acoustic reproduction device 100.

First, the test audio signal generator 101 generates a test audio signal (S1801). The electric/acoustic output converter 102 converts the test audio signal from an electrical signal to reproduction sound and outputs it to the reproduction system 150 (S1802).

The acoustic/electric input converter 103 picks up the test reproduction sound propagating in the reproduction system 150, and converts it from reproduction sound to an electrical signal (S1803).

The impulse response calculator 104 calculates an impulse response of the reproduction system 150 comprising a reproduction sound field from the electrical signal converted from the test reproduction sound (S1804).

The reverse characteristic calculator 105 calculates the reverse characteristics of the impulse response calculated by the impulse response calculator 104 (S1805).

The tap extractor 106 extracts an FIR filter having a predetermined number of taps from the FIR filter having the calculated reverse characteristics (S1806).

The coefficient calculator 107 calculates a string of compensation coefficients to compensate for tap coefficients such that the absolute value of the total sum of the tap coefficients becomes “1” (S1807).

The adder 108 adds each compensation coefficient contained in the calculated compensation coefficient string to the tap coefficient of each tap of the extracted FIR filter, thereby generating a compensation filter to compensate for acoustic characteristics of the reproduction system (1808).

The adder 108 sets the generated compensation filter to the filter 110 (S1809).

In this manner, the audio signal is corrected with the compensation filter having tap coefficients compensated for by compensation coefficients.

As described above, the acoustic reproduction device 100 of the embodiment compensates for an extracted FIR filter with compensation coefficients to achieve desired characteristics.

If using an FIR filter having a fewer taps, i.e., less arithmetic operations, the acoustic reproduction device 100 of the embodiment can suitably compensate for amplitude characteristics in the low frequency range.

According to the embodiment, the acoustic reproduction device 100 can suppress a gain drop in the low frequency range by adjusting filter coefficients. Thus, if using an inexpensive filter having a fewer taps that can be mounted on a digital signal processor (DSP), it is possible to achieve favorable acoustic pressure characteristics in the low frequency range.

While an example is described above in which a vector to be added to an extracted impulse response is obtained by multiplying the Tukey (tapered cosine) window function by a coefficient, the rectangular window can be used with the same effect. Besides, the absolute value of the total sum of tap coefficients is described as being set to “1”, this is by way of example only. For example, an arbitrary gain can be set to double the DC gain (6 dB) by adding compensation coefficients that make the absolute value of the total sum of tap coefficients become 2.

According to the embodiment, the acoustic reproduction device 100 compensates for the tap coefficient of each tap by a compensation coefficient, thereby realizing a filter the amplitude characteristics of which do not degrade in the low frequency range if using a compensation filter (FIR filter) having a few taps.

According to the embodiment, the acoustic reproduction device 100 does not need to additionally have a low-pass filter to set basic sound quality. Thus, it is possible to avoid an increase in arithmetic operations for signal processing and circuit size. Further, the acoustic reproduction device 100 can achieve favorable acoustic pressure characteristics in the low frequency range with less need to rely on acoustic low-frequency enhancement without a cost increase. In other words, the acoustic reproduction device 100 can achieve both processing load reduction and accuracy enhancement.

While the acoustic reproduction device 100 of the embodiment is described as generating a compensation filter as well as performing filtering using the generated compensation filter, it is not so limited. For example, the acoustic reproduction device may comprise an output module that outputs an audio signal and a filter that performs filtering on the audio signal output from the output module using a compensation filter generated and set by another filtering device in a manner as described above.

While the acoustic reproduction device 100 is described by way of example above as being installed in a television receiver, it may be applied to other devices. For example, the acoustic reproduction device 100 may be applied to an external speaker provided to a personal computer or the like. The acoustic reproduction device 100 may also be applied to acoustic equipment such as compact disc (CD) players. The acoustic reproduction device 100 may be built in a mobile telephone, and may also be applied to headphones.

The acoustic reproduction device 100 installed in a television receiver has a hardware configuration comprising a central processing unit (CPU), a read only memory (ROM), and a random access memory (RAM). A computer program (hereinafter, “acoustic processing program”) can be executed on a computer to realize the same function as the acoustic reproduction device 100 of the above embodiment. The acoustic processing program may be provided as being stored in advance in ROM or the like.

The acoustic processing program comprises modules that implement the above constituent elements (including the test audio signal generator, the electric/acoustic output converter, the acoustic/electric input converter, the impulse response calculator, the reverse characteristic calculator, the tap extractor, the coefficient calculator, the adder, and the filter). As real hardware, the CPU loads the acoustic processing program from the ROM into the RAM and executes it. With this, the test audio signal generator, the electric/acoustic output converter, the acoustic/electric input converter, the impulse response calculator, the reverse characteristic calculator, the tap extractor, the coefficient calculator, the adder, and the filter are implemented on the RAM.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A compensation filtering device comprising:
an impulse response calculator configured to calculate an impulse response of a reproduction system comprising a sound field;
a coefficient calculator configured to calculate a compensation coefficient to compensate for a tap coefficient such that a direct current gain of an extracted finite impulse response (FIR) filter with a predetermine number of taps extracted from an FIR filter having reverse characteristics of the impulse response takes a predetermined value, the tap coefficient indicating a weight of each of the taps; and
an adder configured to add the compensation coefficient to the tap coefficient of each of the taps of the extracted FIR filter to generate a compensation filter to compensate for acoustic characteristics of the reproduction system.

2. The compensation filtering device of claim 1, wherein the coefficient calculator is configured to calculate an identical compensation coefficient for a plurality of taps of the extracted FIR filter.

3. The compensation filtering device of claim 2, wherein the coefficient calculator is configured to calculate the compensation coefficient based on a Tukey (tapered cosine) window function.

4. The compensation filtering device of claim 1, wherein the coefficient calculator is configured to calculate the compensation coefficient such that an absolute value of a total sum of all the taps of the extracted FIR filter becomes 1.

5. The compensation filtering device of claim 1, further comprising:
an output module configured to output an audio signal; and
a filter configured to perform filtering on the audio signal output from the output module with the compensation filter generated by the adder.

6. The compensation filtering device of claim 1, further comprising:
a reverse characteristic calculator configured to calculate reverse characteristics of the impulse response calculated by the impulse response calculator; and
an extractor configured to extract the FIR filter with the predetermine number of taps from the FIR filter having the reverse characteristics calculated by the reverse characteristic calculator.

7. A compensation filtering device comprising:
an output module configured to output an audio signal; and
a filter configured to perform filtering on the audio signal output from the output module using a compensation filter in which a tap coefficient is compensated for such that a direct current gain of a finite impulse response (FIR) filter with a predetermine number of taps extracted from an FIR filter having reverse characteristics of an impulse response of a reproduction system comprising a sound field takes a predetermined value, the tap coefficient indicating a weight of each of the taps.

8. A compensation filtering method comprising:
calculating, by an impulse response calculator, an impulse response of a reproduction system comprising a sound field;
calculating, by a coefficient calculator, a compensation coefficient to compensate for a tap coefficient such that a direct current gain of an extracted finite impulse response (FIR) filter with a predetermine number of taps extracted from an FIR filter having reverse characteristics of the impulse response takes a predetermined value, the tap coefficient indicating a weight of each of the taps; and
adding, by an adder, the compensation coefficient to the tap coefficient of each of the taps of the extracted FIR filter to generate a compensation filter to compensate for acoustic characteristics of the reproduction system.
